(19) United States
(12) Patent Application Publication
(10) Pub. No.: US 2024/0109589 A1
(43) Pub. Date: Apr. 4, 2024

(54) SUBFRAME STRUCTURE

(71) Applicant: HONDA MOTOR CO., LTD., Tokyo (JP)

(72) Inventors: Ryosuke KUNO, Wako-shi (JP); Isao OBATA, Wako-shi (JP); Shosuke OHHAMA, Wako-shi (JP)

(21) Appl. No.: 18/477,134

(22) Filed: Sep. 28, 2023

(30) Foreign Application Priority Data
Sep. 30, 2022 (JP) 2022-157519

(51) Int. Cl. B62D 21/11; B62D 3/12

(52) U.S. Cl. CPC B62D 21/11; B62D 3/12

(57) ABSTRACT

In a subframe structure in a vehicle including a steering rack mechanism and a subframe structure body having a plurality of fixation portions fixed to a vehicle body, the steering rack mechanism has an outer tubular portion extending in a vehicle width direction, and the subframe main body and the outer tubular portion are integrally formed.

### CROSS-REFERENCE TO RELATED APPLICATION

This application is based upon and claims priority from the Japanese Patent Application No. 2022-157519, filed on Sep. 30, 2022, the entire contents of which are incorporated herein by reference.

### BACKGROUND OF THE INVENTION

### 1. Field of the Invention

The present invention relates to a subframe structure in a vehicle including a steering rack mechanism and a subframe having a plurality of fixation portions fixed to a vehicle body.

### 2. Description of the Related Art

For example, JP4231473B discloses a structure in which a separately-configured steering rack is fastened and fixed to a subframe using fastening/fixation parts such as bolts via two intermediate brackets.

In regards to the parts for fastening and fixing the steering rack to the subframe, for example, a reinforcement member such as a stiffener may be needed in some cases.

Further, in recent years, efforts have been actively made toward providing an access to a sustainable transportation system taking into account vulnerable road users, such as the elderly and children. To achieve this, energies have been put into research and development to further improve traffic safety and convenience through research and development related to collision safety performance.

From the perspective of rigidity and strength of the steering rack against input from tie rods, for example, stress tends to concentrate at the fastening/fixation sites such as bolts, which may hinder desired rigidity and strength from being achieved.

Also, to transmit load inputted to the subframe or the body, a reinforcement member is additionally needed, such as additionally disposing, for example, a bolt-fastened stiffener or the like, and this may increase the weight of the vehicle body. Also, from the perspective of performance for collision safety, desired rigidity and strength need to be achieved.

### SUMMARY OF THE INVENTION

The present invention has been made in view of the above-described points, and has an object to provide a subframe structure capable of avoiding concentration of stress on fastening/fixation sites on a steering rack in prior art. Then by extension, this contributes to development of a sustainable transportation system.

The present invention to achieve the above object provides a subframe structure in a vehicle including a steering rack mechanism and a subframe having a plurality of fixation portions fixed to a vehicle body, in which the steering rack mechanism has an outer tubular portion extending in a vehicle width direction, and the subframe and the outer tubular portion are integrally formed.

The present invention can provide a subframe structure capable of omitting fastening/fixation sites on a steering rack in prior art and thereby reducing concentration of stress on the fastening/fixation sites on the steering rack in prior art.

### BRIEF DESCRIPTION OF THE DRAWINGS

FIG. 1 is a perspective view of a subframe structure body to which a subframe structure according to an embodiment of the present invention is applied, the subframe structure body being seen at an angle in a left vehicle-rear direction.

FIG. 2 is a perspective view of the subframe structure body shown in FIG. 1 seen at an angle in a right vehicle-front direction.

FIG. 3 is a plan view of the subframe structure body shown in FIG. 1.

FIG. 4 is a partially-enlarged perspective view of the subframe structure body shown in FIG. 1.

FIG. 5 is a sectional view taken along the line V-V in FIG. 1.

FIG. 6 is a sectional view showing how a lower end portion of a lower rib is linked to a jack member.

FIG. 7 is a front view showing a path of transmission of tie rod input F1.

FIG. 8 is a plan view showing paths of transmission of the tie rod input F1 and drive reaction force F2.

### DETAILED DESCRIPTION OF THE EMBODIMENTS

Next, an embodiment of the present invention is described in detail with reference to the drawings where necessary. Note that throughout the drawings, “front” and “rear” denote a vehicle front-rear direction, “left” and “right” denote a vehicle width direction (a left-right direction), and “up” and “down” denote a vehicle up-down direction (a vertical up-down direction).

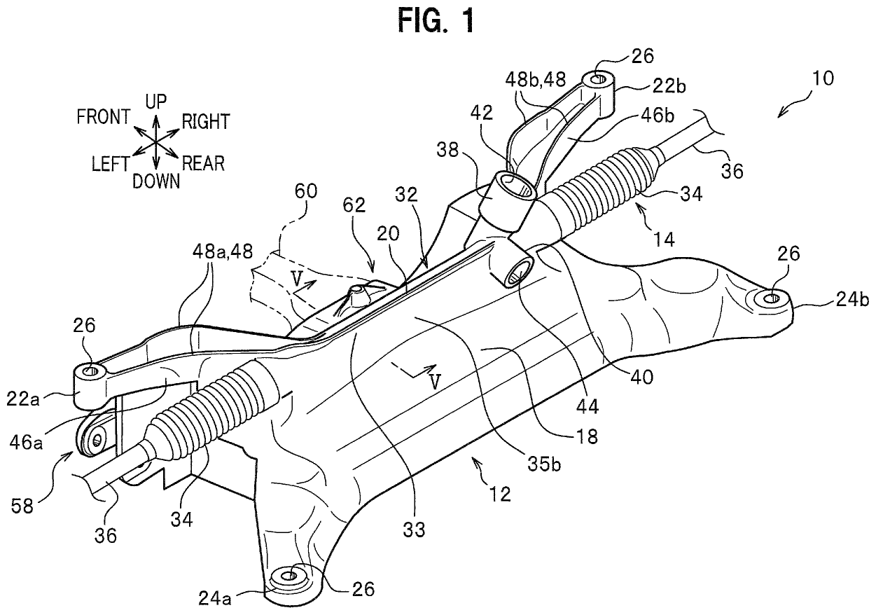

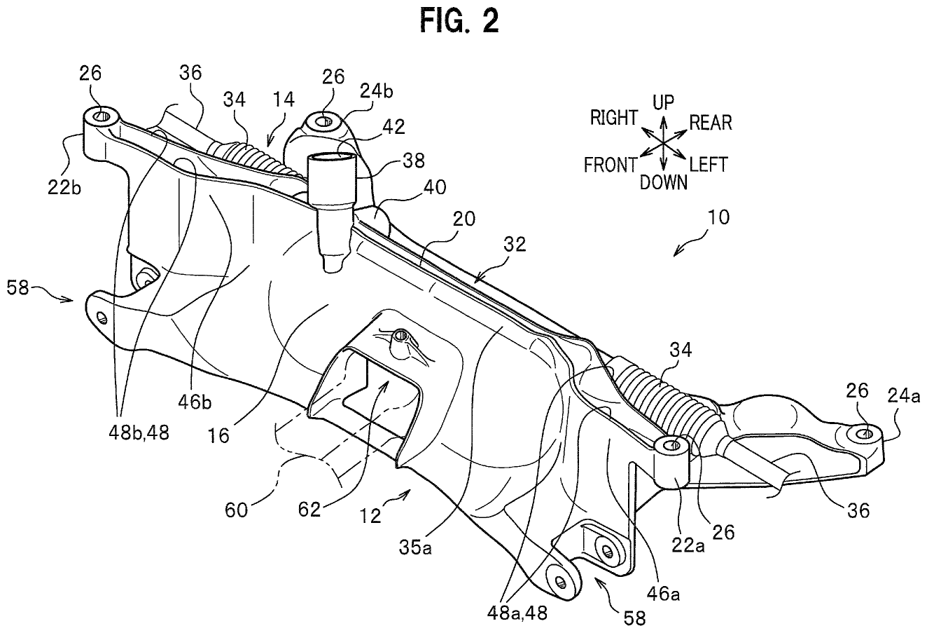

As shown in FIGS. 1 and 2, a subframe structure body 10 to which a subframe structure according to the embodiment of the present invention is applied is configured including a subframe main body 12, a steering rack mechanism 14, and a plurality of fixation portions for fixing the subframe main body 12 to a member on the vehicle body side (not shown).

The subframe main body 12 has a front wall 16 facing the vehicle front and a rear wall 18 facing the vehicle rear. A vehicle-upper edge portion of the front wall 16 and a vehicle-upper edge portion of the rear wall 18 are formed integrally via an outer tubular portion 32 (to be described later) mounted at an upper portion of the subframe main body 12. At the respective sides of the subframe main body 12 in the vehicle width direction at the vehicle front side, a front left fixation portion 22a and a front right fixation portion 22b are disposed, extending from the subframe main body 12 outward in the vehicle width direction. Also, at the respective sides of the subframe main body 12 in the vehicle width direction at the vehicle rear side, a rear left fixation portion 24a and a rear right fixation portion 24b are disposed, extending from the subframe main body 12 outward in the vehicle width direction.

The subframe structure body 10 is fixed to a member on the vehicle body side (not shown) via a plurality of fixation portions: the front left fixation portion 22a, the front right fixation portion 22b, the rear left fixation portion 24a, and the rear right fixation portion 24b. For example, the subframe structure body 10 is attached via the plurality of fixation portions, suspended between paired left and right side frames (not shown) which are disposed at the respective sides in the vehicle width direction and extend in the vehicle front-rear direction. Each of the fixation portions of the subframe main body 12 is provided with a bolt insertion hole 26 penetrating in the up-down direction, and a bolt (not shown) is inserted through the bolt insertion hole 26 and fastened and fixed by a nut (not shown).

The steering rack mechanism 14 is disposed at one side of the subframe structure body 10 in the vehicle width direction (the right side or the left side depending on whether the vehicle is a right-hand drive or a left-hand drive).

This steering rack mechanism 14 converts rotational motion of a steering handle (not shown) into a horizontal operation of a steering rack 28 and transmits it to the left and right tires.

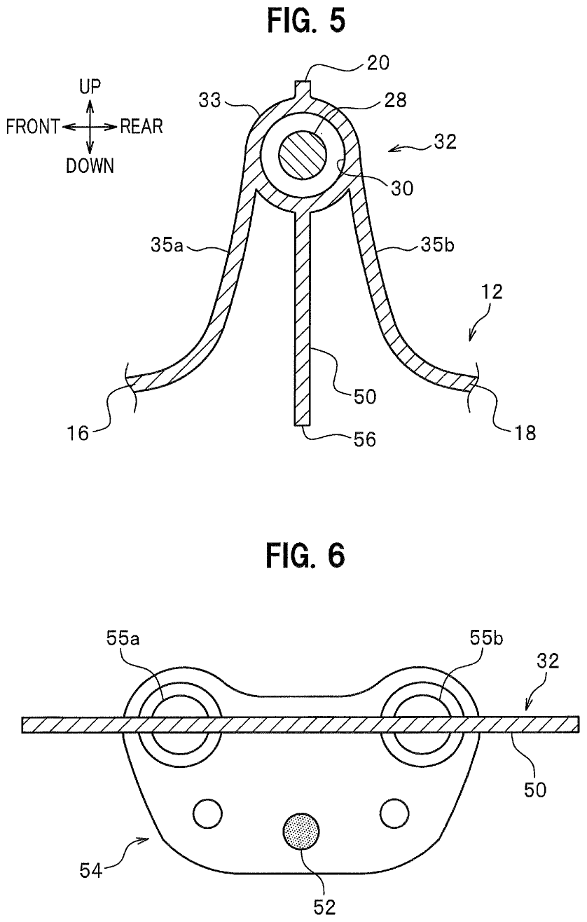

The steering rack mechanism 14 includes, for example, the steering handle (not shown), a steering shaft (not shown) which is linked to the center of the steering handle and turns integrally with the steering handle, and a rack and pinion (not shown) (the steering rack 28 (see FIG. 5) and a pinion shaft) provided at the lower end of the steering shaft.

Further, the steering rack mechanism 14 is configured including the outer tubular portion 32 having a through-hole 30 inside which the steering rack 28 is housed in such a manner as to be displaceable in the vehicle width direction, paired left and right steering boots 34 which are accordion-shaped and cover the left and right end portions of the steering rack 28, respectively, and paired left and right tie rods 36 connected to the respective end portions of the steering rack 28.

In the subframe structure body 10 in the present embodiment, the outer tubular portion 32, which is mounted at the upper portion of the subframe main body 12 and extends in the vehicle width direction, is formed integrally with the subframe main body 12. The outer tubular portion 32 is located between its top portion 20 and the subframe main body 12 in the vehicle up-down direction (see FIGS. 1 and 2).

As shown in FIG. 5, the outer tubular portion 32 has the top portion 20 located highest and having a ridge line extending straight partly in the vehicle width direction, an annular body 33 internally having the through-hole 30 which is substantially circular in a cross section taken perpendicular to the axis, extends in the vehicle width direction, and houses the steering rack 28, a vehicle-front sleeve portion 35a extending down from a vehicle-front side of the annular body 33 and connecting to the front wall 16, a vehicle-rear sleeve portion 35b extending down from a vehicle-rear side of the annular body 33 and connecting to the rear wall 18, and a lower rib 50 (to be described later) extending down from a lower portion of the annular body 33. Each of the end portions of the annular body 33 in the vehicle width direction is provided with an insertion port (not shown) for the steering rack 28.

At a site on one side of the outer tubular portion 32 in the vehicle width direction, a pinion shaft insertion portion 38 and a motor shaft insertion portion 40 are provided. The pinion shaft insertion portion 38 is formed of a tubular body protruding from an upper end of the outer tubular portion 32 to the vehicle upper side and has a pinion shaft insertion hole 42 through which to insert a lower end portion of the pinion shaft (not shown). The motor shaft insertion portion 40 is formed of a tubular body protruding from an upper portion of the outer tubular portion 32 to the vehicle rear side and has a motor shaft insertion hole 44 through which to insert a motor shaft of a motor (not shown).

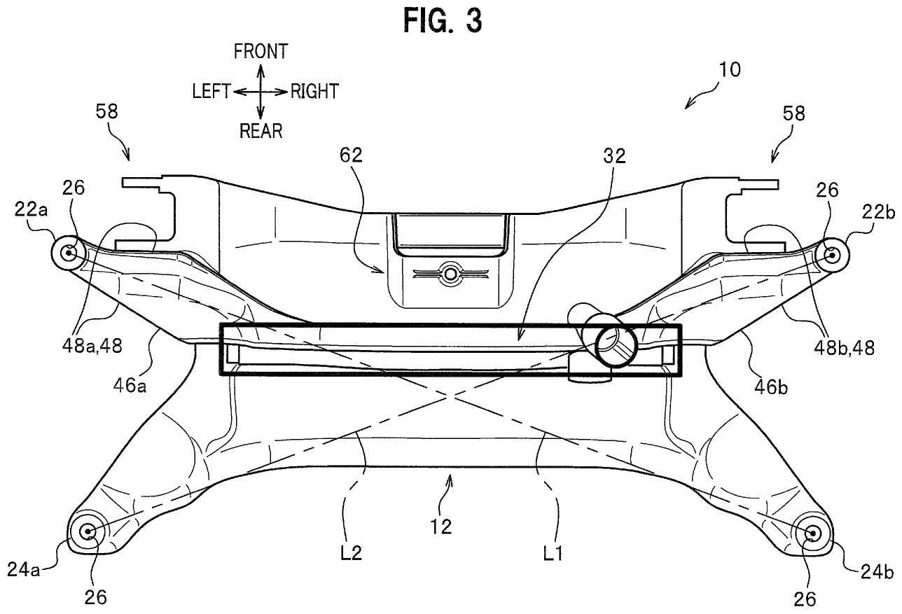

Now, the positional relations between the outer tubular portion 32 and the plurality of fixation portions are described. First, an imaginary line connecting at least two diagonally-located ones of the plurality of fixation portions is considered. For example, as shown in FIG. 3, the centers of the front left fixation portion 22a and the rear right fixation portion 24b of the subframe main body 12 are connected to form a first imaginary line L1. Also, the centers of the front right fixation portion 22b and the rear left fixation portion 24a of the subframe main body 12 are connected to form a second imaginary line L2. The outer tubular portion 32 extending straight in the vehicle width direction is disposed to intersect with each of the first imaginary line L1 and the second imaginary line L2.

Also, the subframe structure body 10 has paired left and right extension portions 46a, 46b (see FIG. 3) which extend continuously from the vehicle-width-direction end portions of the outer tubular portion 32 to the front left fixation portion 22a and the front right fixation portion 22b along the diagonal lines (the first imaginary line L1 and the second imaginary line L2), respectively. The left extension portion 46a is disposed in such a manner as to extend continuously from a front portion of the vehicle-width-direction left end portion of the outer tubular portion 32 along the first imaginary line L1 in a plan view. The right extension portion 46b is disposed in such a manner as to extend continuously from a front portion of the vehicle-width-direction right end portion of the outer tubular portion 32 along the second imaginary line L2 in a plan view.

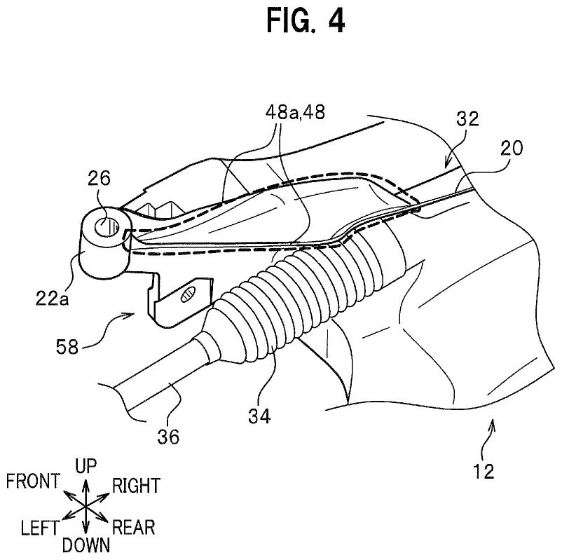

Further, the subframe structure body 10 is provided with an upper rib 48 connecting the outer tubular portion 32 to the front fixation portions. This upper rib 48 is formed by a left upper rib 48a connecting the front left fixation portion 22a to a vehicle-width-direction left end portion of the outer tubular portion 32 in the vehicle width direction and a right upper rib 48b connecting the front right fixation portion 22b to a vehicle-width-direction right end portion of the outer tubular portion 32 in the vehicle width direction. The left upper rib 48a and the right upper rib 48b are each formed by two projecting portions extending in the vehicle width direction (see FIGS. 1 to 4). A concave portion sinking to the vehicle lower side is provided between the two projecting portions. The left upper rib 48a and the right upper rib 48b connect the outer tubular portion 32 to the corresponding front fixation portions in order to improve the rigidity and strength of the subframe structure body 10.

As shown in FIG. 5, at a lower surface portion of the outer tubular portion 32, the lower rib 50 is provided integrally with the outer tubular portion 32, extending downward in the vehicle up-down direction. This lower rib 50 extends in the vehicle width direction continuously from a vehicle-width-direction left end portion to a vehicle-width-direction right end portion of the outer tubular portion 32. As shown in FIG. 6, part of a lower edge portion 56 of the lower rib 50 is linked to a jack member 54 having a jack-up point 52. Note that the reference numerals 55a, 55b in FIG. 6 denote joint portions between the lower edge portion 56 of the lower rib 50 and the jack member 54. The remaining portions of the lower edge portion 56 of the lower rib 50 except for the portions linked to the jack member 54 are free ends.

Further, each of the left and right sides of the subframe main body 12 is provided with a lower-arm fastening portion 58 to which an end portion of a suspension lower arm (not shown) is fastened via a bushing (not shown) (see FIG. 2). Also, provided at substantially the center between the left and right lower-arm fastening portions 58 is a torque rod fastening portion 62 for fastening a torque rod 60.

The subframe structure body 10 to which the subframe structure according to the present embodiment is applied is basically configured as described above. Next, its operations and advantageous effects are described.

In the present embodiment, the steering rack mechanism 14 has the outer tubular portion 32 extending in the vehicle width direction, and the subframe main body 12 and the outer tubular portion 32 are integrally formed.

Thus, the present embodiment can omit the fastening/fixation sites on the steering rack provided in prior art and consequently reduce the concentration of stress caused at the fastening/fixation sites in prior art. As a result, the rigidity and strength of the steering rack 28 can be improved.

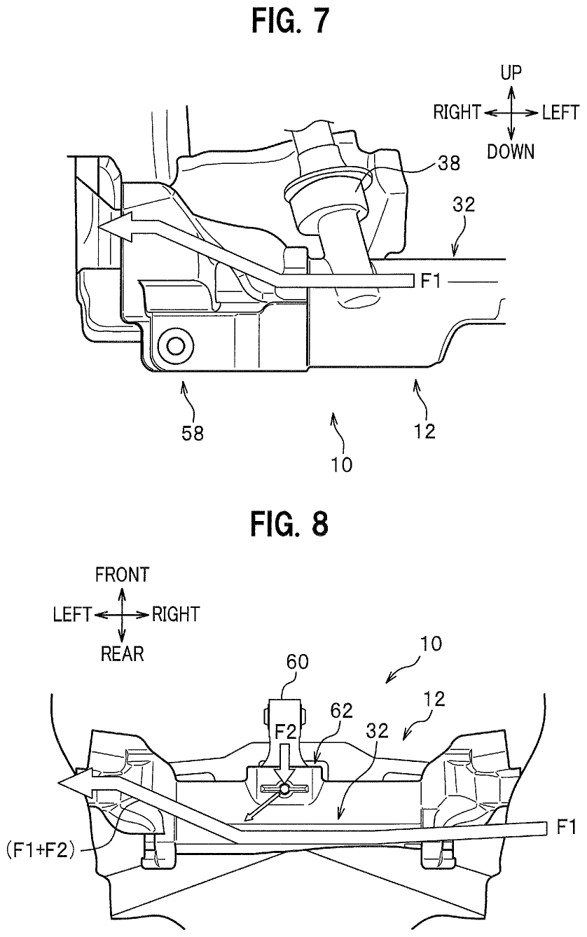

FIG. 7 is a front view showing a path of transmission of tie rod input in the subframe structure body according to the present embodiment, and FIG. 8 is a plan view showing paths of transmission of tie rod input and drive reaction force.

In prior art, tie rod input is disconnected at fastening/fixation sites on the steering rack, causing concentration of stress. By contrast, in the present embodiment, the subframe main body 12 and the outer tubular portion 32 are integrally formed as shown in FIG. 7, so that the fastening/fixation sites on the steering rack provided in prior art can be omitted, and thus, the force of a tie rod input F1 can be smoothly transmitted (see the open arrow shown in FIG. 7).

Further, in the present embodiment, the tie rod input F1 is added with drive reaction force F2 inputted from the torque rod 60 (F1+F2) as shown in FIG. 8, which helps smooth force transmission (see the open arrow shown in FIG. 8). Note that the tie rod input F1 and the drive reaction force F2 added together (F1+F2) are transmitted to a member on the vehicle body side (not shown) via the fixation portions.

Also, in the present embodiment, the integral formation of the subframe main body 12 and the outer tubular portion 32 enables reduction in the number of parts, which in turn reduces manufacturing costs and weight. Further, because the annular body 33 of the outer tubular portion 32, which is circular in section perpendicular to the axis (see FIG. 5), functions as a subframe, the rigidity and strength of the subframe structure body 10 improve. Furthermore, no attachment error or the like occurs at fixation points where the subframe structure body 10 is fixed to a member on the vehicle body side via the fixation portions, and therefore, the positional relation between the steering rack 28 and the subframe structure body 10 is ensured, which leads to improvement in the product quality of the subframe structure body 10.

Also, in the present embodiment, the first imaginary line L1 and the second imaginary line L2 each connecting at least two diagonally-located ones of the plurality of fixation portions are set (the first imaginary line L1 is an imaginary line connecting the center of the front left fixation portion 22a and the center of the rear right fixation portion 24b, and the second imaginary line L2 is an imaginary line connecting the center of the front right fixation portion 22b and the center of the rear left fixation portion 24a). Then, the outer tubular portion 32 is disposed to intersect with the first imaginary line L1 and the second imaginary line L2 (see FIG. 3).

In the present embodiment in which the outer tubular portion 32 formed integrally with the subframe main body 12 is thus located on the diagonal lines between the fixation portions, the thickness dimension of the subframe main body 12, which is smaller in prior art in order to avoid the steering rack, can be increased by the outer tubular portion 32. As a result, in the present embodiment, the rigidity and strength of the subframe structure body 10 against twisting can be improved.

Further, in the present embodiment, the subframe structure body 10 has the paired left and right extension portions 46a, 46b extending continuously from the outer tubular portion 32 to the front left fixation portion 22a and the front right fixation portion 22b along the diagonal lines (the first imaginary line L1 and the second imaginary line L2), respectively.

In the present embodiment in which the paired left and right extension portions 46a, 46b are thus provided, the extension portions 46a, 46b can accept twisting stress inputted to the subframe structure body 10. As a result, the present embodiment can not only reduce concentration of stress, but also further improve the rigidity and strength of the subframe structure body 10 against twisting.

Further, in the present embodiment, the subframe structure body 10 is provided with the upper rib 48 connecting the front left fixation portion 22a and the front right fixation portion 22b to the respective vehicle-width-direction end portions of the outer tubular portion 32 in the vehicle width direction.

In the present embodiment in which the upper rib 48 is thus provided, load inputted to the outer tubular portion 32 by steering can be transmitted to the front left fixation portion 22a and the front right fixation portion 22b via the upper rib 48. As a result, in the present embodiment, the rigidity and strength of the steering rack mechanism 14 can be improved. Also, when the vehicle-width-direction end portions of the outer tubular portion 32 in the vehicle width direction are located on the diagonal lines, the upper rib 48 too can be disposed on the diagonal lines, which makes it possible to improve the rigidity and strength of the subframe structure body 10 against twisting. Further, the upper rib 48 functions as a heat barrier member against the steering components such as, for example, the tie rods 36 and the steering boots 34 disposed below the upper rib 48, thereby providing favorable protection from heat from the peripheral components.

Also, in the present embodiment, the lower rib 50 is provided at the lower surface portion of the outer tubular portion 32, extending downward in the vehicle up-down direction.

By the provision of the lower rib 50, the present embodiment can improve the rigidity and strength of the outer tubular portion 32 and of the steering rack 28 housed in the outer tubular portion 32.

Also, in the present embodiment, the lower edge portion 56 of the lower rib 50 is linked to the jack member 54 having the jack-up point 52.

Thus, the present embodiment can ensure sufficient rigidity and strength for the jack member 54 because the jack-up point 52 can be disposed at the portion having the lower rib 50 where rigidity and strength are high.

What is claimed is:

1. A subframe structure in a vehicle including a steering rack mechanism and a subframe having a plurality of fixation portions fixed to a vehicle body, wherein
the steering rack mechanism has an outer tubular portion extending in a vehicle width direction, and
the subframe and the outer tubular portion are integrally formed.

2. The subframe structure according to claim 1, wherein
imaginary lines are provided, each connecting at least two diagonally-located ones of the plurality of fixation portions, and
the outer tubular portion is disposed to intersect with the imaginary lines.

3. The subframe structure according to claim 2, wherein
the subframe has paired left and right extension portions continuously extending from the outer tubular portion to the fixation portions along the diagonal lines.

4. The subframe structure according to claim 1, wherein
the subframe is provided with an upper rib connecting at least one of the fixation portions to a vehicle-width-direction end portion of the outer tubular portion in the vehicle width direction.

5. The subframe structure according to claim 3, wherein
the subframe is provided with an upper rib connecting at least one of the fixation portions to a vehicle-width-direction end portion of the outer tubular portion in the vehicle width direction.

6. The subframe structure according to claim 1, wherein
a lower rib is provided at a lower surface portion of the outer tubular portion, extending downward in a vehicle up-down direction.

7. The subframe structure according to claim 3, wherein
a lower rib is provided at a lower surface portion of the outer tubular portion, extending downward in a vehicle up-down direction.

8. The subframe structure according to claim 6, wherein
a lower end portion of the lower rib is linked to a jack member having a jack-up point.

9. The subframe structure according to claim 7, wherein
a lower end portion of the lower rib is linked to a jack member having a jack-up point.
